(19) United States
(12) Patent Application Publication
(10) Pub. No.: US 2026/0145888 A1
(43) Pub. Date: May 28, 2026

(54) METHOD AND DEVICE FOR TRANSFERRING FLOATING BIOMASS

(71) Applicant: GreenOnyx LTD, Tel Aviv (IL)

(72) Inventors: Guy STEINBERG, Maor (IL); Tsipi SHOHAM, Tel Aviv (IL)

(21) Appl. No.: 18/956,879

(22) Filed: Nov. 22, 2024

(51) Int. Cl. B65G 53/30; A01G 31/02; B65G 53/36

(52) U.S. Cl. CPC B65G 53/30; A01G 31/02; B65G 53/36; B65G 2812/99

(57) ABSTRACT

Methods for transferring floating biomass from a container, the method comprising: (a) providing a container for holding said biomass and fluid, wherein said container comprises at least two horizontally aligned orifices; (b) elevating a fluid level of said fluid in said container to a height of at least one of said horizontally aligned orifices; and (c) flowing a carrier fluid through at least one of said horizontally aligned orifices to stream at least a portion of a top layer of said floating biomass out of said container and through at least one other of said horizontally aligned orifices, thereby transferring at least one layer portion of said floating biomass from said container out of said container.

### TECHNICAL FIELD

The present disclosure generally relates to the processing of biomass. More particularly, embodiments relate to the transferring of floating biomass.

### BACKGROUND

An example of floating biomass are aquatic edible plants, which are convenient, tasty, and an excellent source of protein, dietary fibers, essential minerals (dietary chemical elements), key vitamins, and other phytochemicals (e.g. antioxidants) needed for a healthy diet. Thus, cultivating and processing aquatic plants and the distribution of these aquatic plants are fields of interest. Thus, a need arises to efficiently cultivate and transfer these floating plants.

Lemnaceae is a family of aquatic plants, also known as the duckweed family. Duckweeds are fast-growing and high-pigment-containing monocotyledonous plants and are classified as macrophytes. The duckweeds have a simple structure, lacking an obvious stem or leaves, where the greater part of each plant is a few cells thick, with air pockets (aerenchyma) that allow it to float on the water surface.

US 2012117869 discloses an apparatus for culturing aquatic species comprising: a container configured to contain the aquatic species in sufficient culture medium to permit normal growth of the aquatic species, wherein the container has a configuration allowing the culture medium to flow in a continuous loop; a propulsion mechanism configured to apply sufficient force to the culture medium to cause motion thereof; and an automated harvest system configured to permit harvest of the aquatic species without ceasing the motion. Nevertheless, the disclosed apparatus is cumbersome and requires complex automation.

Accordingly, a continuing need exists for improvements in processing, cultivating, and transferring floating biomass, such as floating aquatic plants. In particular, new methods and systems for transferring floating biomass without cumbersome or complex mechanical mechanisms are desirable.

### SUMMARY

It is an object of the present disclosure to provide a device and method for transferring floating biomass in a continuous and steady flow.

It is another object of the present disclosure to provide an efficient and reliable method for removing floating biomass, from a receptacle, without affecting or damaging the biomass.

It is still another object of the present disclosure to provide an efficient and reliable method for transferring floating biomass with minimal biomass residue and minimal use of fluids.

It is still another object of the present disclosure to provide an efficient and reliable device for transferring floating biomass from place to place while washing the biomass en route.

Other objects and advantages of embodiments according to the present disclosure will become apparent as the description proceeds.

The present disclosure relates to a method for transferring floating biomass from a container, the method comprising: (a) providing a container for holding said biomass and fluid, wherein said container comprises at least two horizontally aligned orifices; (b) elevating a fluid level of said fluid in said container to a height of at least one of said horizontally aligned orifices; and (c) flowing a carrier fluid through at least one of said horizontally aligned orifices to stream at least a portion of a top layer of said floating biomass out of said container and through at least one other of said horizontally aligned orifices, thereby transferring at least one layer portion of said floating biomass from said container out of said container.

Preferably, the method further comprises: continuing to flow the carrier fluid through the at least one of the horizontally aligned orifices to continue the stream of floating biomass out of said container through the at least one other orifice, of said horizontally aligned orifices, to transfer most of said floating biomass from said container out of said container.

According to some embodiments, the floating biomass is transferred out of the container until a minimal residue of less than 0.01% of an initial batch of biomass within the container is left in the container.

According to some embodiments, the floating biomass is transferred out of the container until a minimal residue of less than 30% of an initial batch of biomass within the container is left in the container.

According to some embodiments, the biomass is a floating aquatic plant culture.

According to some embodiments, the biomass is washed en route during the transferring of said biomass from the container.

According to some embodiments, the flow of the carrier fluid into the container is controlled for calculating a total volume amount of the biomass transferred from the container.

According to some embodiments, the biomass transferred from the container is circulated back into the container for calculating the total volume amount of the biomass that was in said container.

The present disclosure also relates to a device for transferring floating biomass, the device comprising a container for holding said floating biomass and fluid and comprising at least two orifices, wherein said at least two orifices are horizontally aligned for flowing carrier fluid through at least one of said horizontally aligned orifices to stream at least a portion of a top layer of said floating biomass out of said container and through at least one other of said horizontally aligned orifices, thereby transferring at least one layer portion of said floating biomass from said container out of said container.

Preferably, the angle between two horizontally aligned orifices, as viewed from above, is between 90-180 degrees.

Preferably, the container comprises a tank and a top.

Preferably, the container further comprises a truncated cone shaped head attached between the tank and the top.

According to some embodiments, the container further comprises strap that attaches the head and the top.

According to some embodiments, the top is shaped like a circular dome.

According to some embodiments, the circular base of the top has a diameter of between 20 mm to 80 mm.

### BRIEF DESCRIPTION OF THE DRAWINGS

The accompanying drawings, and specific references to their details, are herein used, by way of example only, to illustratively describe some of the embodiments of the disclosure.

FIG. 1 is a diagram of a container for holding biomass and fluid, from a perspective view, according to some embodiments.

FIG. 2 is an enlarged diagram of the top of the container, from a perspective view, according to some embodiments.

FIG. 3 is a diagram of a container for holding biomass and fluids, from a front view, according to some embodiments.

FIG. 4 is a diagram of a container tray, from a perspective view, according to some embodiments.

### DETAILED DESCRIPTION

In nature, floating biomass like duckweeds—small biomass units consisting of hundreds of cells with air pockets—often forms extensive “carpets”, i.e. a layer, on the surface of rivers and ponds. Despite their aggregation, duckweeds remain as separate units rather than merging into a single block. This characteristic makes transferring them from one location to another, with minimal residue, a challenging task. Methods and systems according to embodiments of the present disclose utilize devices and flow techniques to efficiently transfer these individual biomass units.

The indefinite articles “a,” “an,” and “the” include plural referents unless clearly contradicted or the context clearly dictates otherwise.

The term “comprising” is an open-ended transitional phrase. A list of elements following the transitional phrase “comprising” is a non-exclusive list, such that elements in addition to those specifically recited in the list can also be present. The phrase “consisting essentially of” limits the composition of a component to the specified materials and those that do not materially affect the basic and novel characteristic(s) of the component. The phrase “consisting of” limits the composition of a component to the specified materials and excludes any material not specified.

As used herein, the term “about” refers to a value that is within ± 10% of the value stated. For example, about 3 degrees can include any number from 2.7 degrees to 3.3 degrees.

As used herein “biomass” may refer to a culture of floating aquatic plants, such as a plant from the Lemnaceae family (duckweed), such as Spirodela plants, Landoltia plants, Lemna plants, Wolffiella plants, or Wolffia plants.

Where a range of numerical values comprising upper and lower values is recited herein, unless otherwise stated in specific circumstances, the range is intended to include the endpoints thereof, and all integers and fractions within the range. It is not intended that the disclosure or claims be limited to the specific values recited when defining a range. Further, when an amount, concentration, or other value or parameter is given as a range, one or more ranges, or as list of upper values and lower values, this is to be understood as specifically disclosing all ranges formed from any pair of any upper range limit or value and any lower range limit or value, regardless of whether such pairs are separately disclosed.

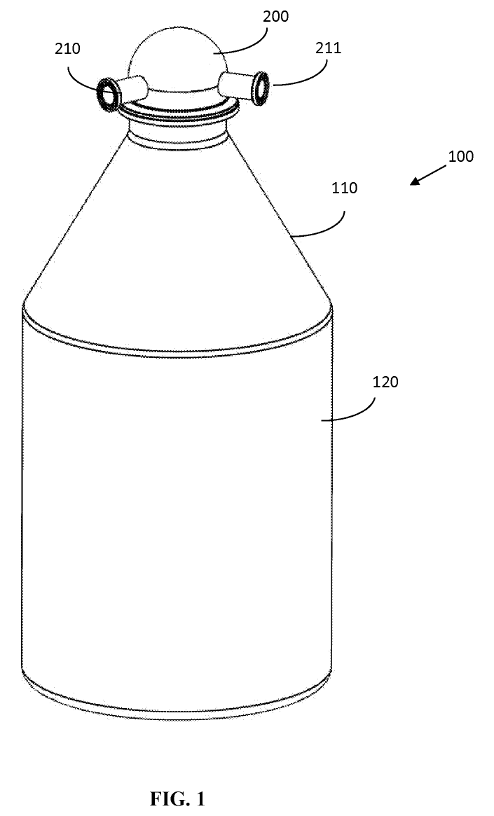

FIG. 1 is a diagram of a container 100 for holding biomass and fluid, from a perspective view, according to some embodiments. The container 100 may be made of any rigid material capable of holding biomass and fluids. The terms “fluid” or “fluids” is meant to include distilled sterile water, mineral water, water with fertilizers (culture medium), or any other fluids. The container 100 comprises a tank 120 for holding biomass and fluid. In some embodiments, the container 100 may further comprise a truncated cone shaped head 110 attached on the tank 120.

The container 100 further comprises a top 200, which may be attached on the head 110 or directly on the tank 120. The top 200 is preferably shaped like a circular dome. In some embodiments, the top 200 may be shaped like a circular cylinder having a circular base and a circular crown.

In some embodiments, a circular base of the tank 120 has a diameter of between 100 mm to 800 mm. In some embodiments, the circular base of the top 200 has a diameter of between 20 mm to 80 mm. In other embodiments, the tank base and the top base may have other diameters. In some embodiments, the tank 120 has a cylinder shape having a diameter that is larger than the diameter of the circular base of the top 200, and the truncated cone shaped head 110 bridges the difference between the larger circumference of the tank 120 and smaller circumference of the top 200. In such embodiments, when the fluid level inside the container 100 is raised (e.g. leveled from the tank to the height of the orifices 210-211), the upper floating biomass layers within the container 100 are narrowed and the floating biomass units are reorganized in an increased number of layers near the upper fluid level in the container 100. In some embodiments the upper angle of the truncated cone 110 is about 60 degrees.

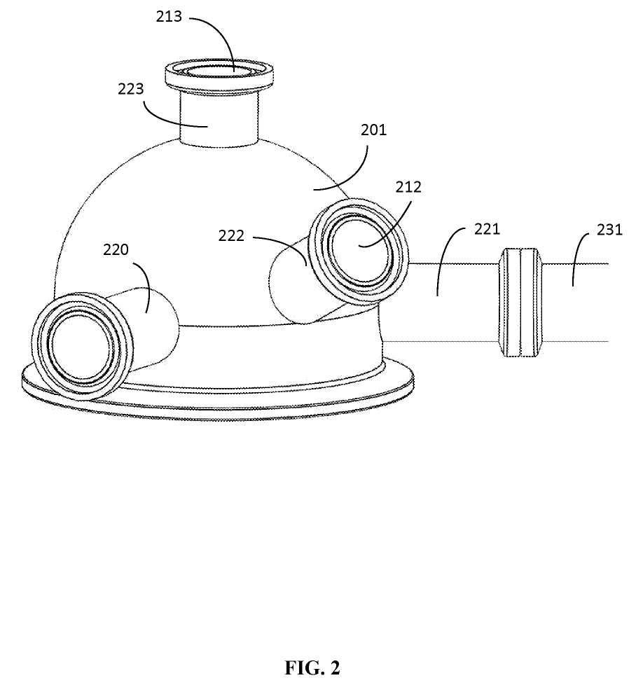

As depicted in FIG. 1, the top 200 of container 100 comprises at least two horizontally aligned orifices, such as orifices 210, 211. The term “horizontally aligned orifices” means orifices that are placed at about the same height, with the height measured in the direction of gravity. In some embodiments, the orifices have connected conduits, e.g. tubes, for attaching tubes or other conduits, such as depicted for example in FIG. 2. The orifices 210, 211 are used for flowing or streaming fluids and/or for transferring biomass to or from the container 100. In order to transfer the biomass from within the container 100 to another place, such as another similar container, the fluid level inside the container 100 is levelled to the height of the two horizontally aligned orifices 210, 211. In some embodiments, the fluid level inside the container is levelled by flowing one or more fluids through one of the orifices 210 or 211. In some embodiments, the fluid level inside the container is levelled to about the vertical center height of at least one of the two horizontally aligned orifices 210, 211.

Once the fluid level is leveled to about the height of the orifices, and the floating biomass within the container is floating in layers near the upper fluid level, carrier fluid is flowed (e.g., in a consistent flow) through at least one orifice, such as orifice 210, effectively pushing a portion of the top layer of biomass to flow, together with at least part of the carrier fluid, out through another orifice, such as orifice 211. Once the top layer portion of the floating biomass is streamed out through orifice 211, the bottom layers of the floating biomass inside the container 100 float upwards where the flow of carrier fluid continues to stream out the new top layer portion of the floating biomass with its carrier fluid throughout orifice 211, for example. This cycle, where the floating biomass float upwards and is streamed out of orifice 211 (e.g., in a steady and consistent flow) may continue until a minimal residue of biomass is left in the container 100.

In some embodiments, the floating biomass is streamed out of an orifice of the container 100 (e.g., orifice 211) until a minimal residue of less than 0.01% of the initial batch of biomass within the container 100 is left in the container 100. In some embodiments, the floating biomass is streamed through orifice 211 until a minimal residue of less than 3% of the initial batch of biomass within the container is left in the container 100. In some embodiments, the floating biomass is streamed though orifice 211 until a minimal residue of less than 10% of the initial batch of biomass within the container is left in the container 100. In some embodiments, the floating biomass is streamed through orifice 211 until a minimal residue of less than 30% of the initial batch of biomass within the container is left in the container 100. In some embodiments, the floating biomass is streamed through orifice 211 until most of said floating biomass is transferred from the container 100 out of said container 100.

In some embodiments, the flow of carrier fluid into the container is controlled to flow in a consistent, continuous, and steady volume per second for streaming the biomass and its carrier fluid in a consistent, continuous, and steady volume out of the container 100. In some embodiments, this consistent, continuous, and steady flow may facilitate calculating, controlling and monitoring the total volume amount of biomass and/or carrier fluid that are transferred from the container 100. For example, if the flow of carrier fluid into the container is set to a certain consistent volume per second and the time for streaming the biomass out of the container is measured, it is possible to calculate the volume amount of the biomass and its carrier fluid that are transferred from the container. Furthermore, if the ratio between the biomass and its carrier fluid is known it is also possible to calculate the volume amount of the biomass transferred from the container.

In some embodiments, the total biomass within a container (e.g., container 100) may be calculated by circulating the biomass from the container back into the container. For example, if the flow of carrier fluid into the container is set to a certain consistent volume per second and the time for streaming the biomass out of the container is measured, it is possible to calculate the volume amount of the biomass that was in the container and then the biomass can be streamed back into the container.

In some embodiments, the two horizontally aligned orifices 210, 211, as described in relation to FIG. 1, are aligned facing each other in a straight line on the same axis, and the angle between the two orifices 210, 211, as viewed from above, is about 180 degrees. In some embodiments, the angle between the two horizontally aligned orifices 210, 211, as viewed from above, is about 120 degrees. In some embodiments, the angle between the two horizontally aligned orifices, as viewed from above, is between 90-180 degrees. In some embodiments, since the angle between the two horizontally aligned orifices can impact the ratio between the biomass and their carrier fluid at output, the angle between the orifices may be set according to the desired coefficient of the biomass volume to its carrier fluid volume.

In some embodiments, the orifices are circular and have inner diameters between 10 mm to 20 mm. In some embodiments, the orifices are circular and have diameters of about 15 mm. In some embodiments, the orifices are circular and have diameters between 5 mm to 30 mm.

FIG. 2 is an enlarged diagram of a top 201, from a perspective view, according to some embodiments. The top 201, similar to the top 200 described in relations to FIG. 1, has at least two horizontally aligned orifices. The orifices may have connected conduits, such as tubes 220, 221, for attaching other tubes, such as tube 231, for flowing and/or streaming fluids and/or for transferring biomass to or from a container (for example, container 100). In some embodiments, floating biomass is flowed into the container by streaming through one of the tubes of the orifices, such as through the tube 221. The biomass, which is carried by a fluid, such as water or culture medium, may flow, with the fluid, from a different container through tube 231 into tube 221, into the orifice of the container, and spill into the container attached below the top 201.

In some embodiments, the top 201 may comprise additional orifices, such as orifice 212, positioned above the orifices of tubes 220 and 221. A tube 222 may be connected to the orifice 212 at a sloping angle for easily spilling of biomass into the container. For example, the biomass mixed with a fluid may flow from a different container, through the tube 222 attached to the orifice 212, and spill into the container attached below the top 201. In some embodiments, the top 201 may also comprise an orifice, such as orifice 213, positioned on the upper part of the top 201, or on any other convenient location, for ventilating air, filtering air, or for accommodating any other operational, maintenance, or supervision needs. In some embodiments, the orifice 213 may have a connected conduit, such as tube 223, for attaching other conduits, measurement devices, filters, etc.

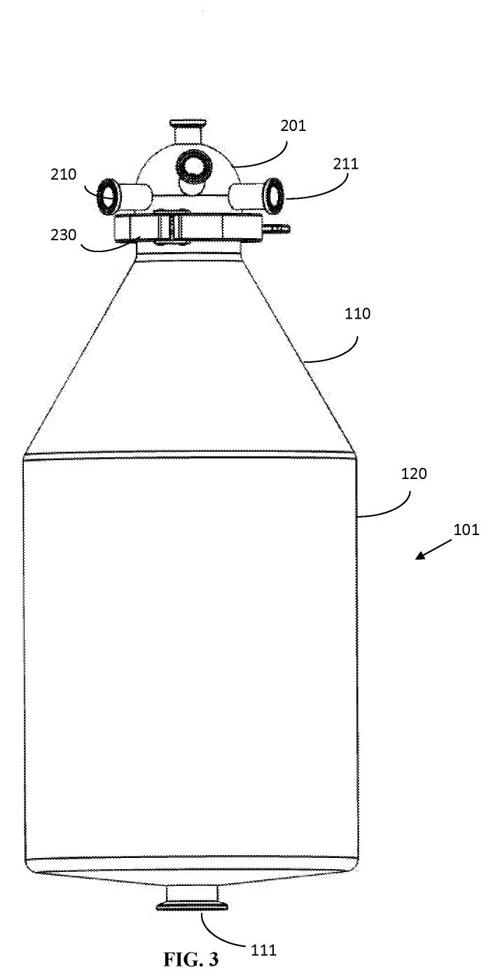

FIG. 3 is a diagram of a container for holding biomass and fluids, from a front view, according to some embodiments. In some embodiments, the container 101, similar to the container 100 described in relation to FIG. 1, may have an orifice 111 at its bottom for flowing fluids into the container 101 or for draining fluids from the container 101. The orifice 111 may also be used for leveling the height of the fluid inside the container 101 to the height of the two horizontally aligned orifices 210, 211, for leveling the height of the floating biomass, which is near the upper fluid level within the container 101, to the height of the orifices 210, 211. In some embodiments, the top 201 may be attached to the head 110 of the container 101 by a strap 230, and may be detached from the head 110 by loosening the strap 230. In some embodiments, the top 201 may be attached to the head 110 of the container 101 or attached directly to the tank 120 by any known means. In some embodiments, the top 201 may be permanently attached in the container 101 or permanently molded in container 101.

In some embodiments, fluid, e.g. water, is streamed through the orifice of the container in order to remove the initial fluid, e.g. culture medium, present between biomass units of a biomass. Thus, for example, it is possible to replace the culture medium of the biomass units with distilled sterile water while transferring the biomass units from one container to another container. In some embodiments, fluid is streamed through one of the orifices of the container in order to level the fluid in the container to the height of the orifices in order to wash part of the culture medium between the biomass units before transferring the biomass units from the container. In some embodiments, carrier fluid, e.g. water, is streamed through an orifice of the container, effectively pushing the top layers of biomass to flow out through another orifice of the container while washing the biomass units from their culture medium en route. Thus, the biomass from the container is washed and streamed out of the container at the same time. In some embodiments, the biomass is washed and returned back to same container by attaching a conduit from one orifice to another. In such embodiments, fluid is streamed through an orifice of the container, effectively pushing the top layers of the floating biomass to flow out through another orifice of the container and return back to the container by yet another orifice, while washing the biomass from its culture medium en route.

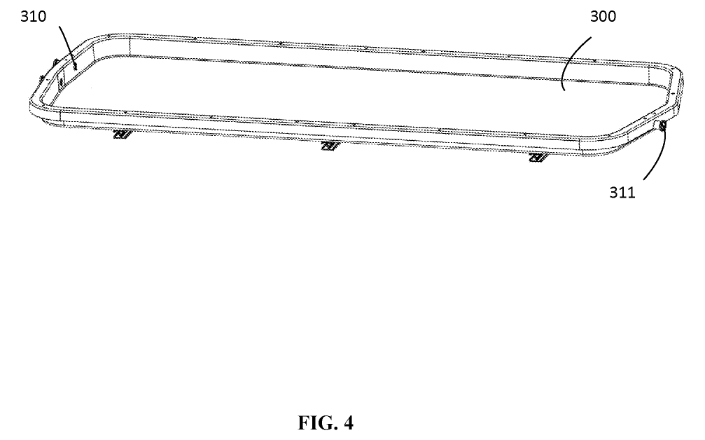

FIG. 4 is a diagram of a tray container, from a perspective view, according to some embodiments. In the diagram, the tray container 300 may be in the shape of a tray made of any rigid material capable of holding floating biomass and fluid. For example, the tray container 300 may be filled with culture medium fluid, as a substrate for growing duckweeds. The culture medium fluid may be for nourishing the duckweeds and providing a desirable environment for the duckweeds to multiply and grow. A small number of duckweeds may be added into the culture medium fluid, sometimes referred to as duckweed planting, where the duckweeds can float, reproduce and grow to form large “carpets” of floating duckweed plants over the culture medium in the tray container 300. The duckweeds, or part of the duckweeds, may then be transferred to a different container, such as container 100 described in relation to FIG. 1. This transfer of duckweeds from tray container 300 to a different container is sometimes referred to as duckweed harvesting.

As depicted in FIG. 4, the tray container 300 comprises at least two horizontally aligned orifices, such as orifices 310, 311. In some embodiments, the orifices have connected conduits for attaching tubes or other conduits as descried herein. The orifices, such as orifices 310, 311, are used for flowing and streaming fluid and/or for transferring biomass in fluid to or from the tray container 300. In order to transfer the biomass from within the tray container 300 to another place, such as another container, the fluid level inside the tray container 300 is levelled to about the height of the two horizontally aligned orifice 310, 311. In some embodiments, the fluid level is leveled to about the vertical center height of the orifices 310, 311.

Once the fluid level is leveled to the height of the orifices, and the floating biomass within the container 300 is floating in a layer near the upper fluid level of the container 300, fluid is flowed through orifice 310, effectively pushing the top layer of the floating biomass to stream out through the orifice 311. The flow of fluid from orifice 310 can continue to stream the floating biomass out of the container 300 through the orifice 311. This flow of fluid may continue in a steady and consistent flow until only a preset percentage of residue of biomass is left in the container 300. The flow of fluid into the container 300 may be controlled and supervised in order to control the stream of floating biomass from the orifice 311. In some embodiments, the floating biomass units are streamed out of orifice 311 until a minimal residue of less than 0.01% of the initial batch of biomass within the container 300 is left in the container 300. In some embodiments, the floating biomass units are streamed throughout orifice 311 until a minimal residue of less than 30% of the initial batch of biomass within the container 300 is left in the container 300. According to some embodiments, the orifices are circular and have an inner diameter of between 15 mm and 33 mm. In some embodiments the diameters of the orifices of the container 300 vary from each other such that the diameter of the orifice 311 may be larger than the diameter of the orifice 310.

While the above description discloses many embodiments and specifications of the invention(s), these were described by way of illustration and should not be construed as limitations on the scope of the invention(s). The described invention(s) may be carried into practice with many modifications which are within the scope of the appended claims.

What is claimed is:

1. A method for transferring floating biomass from a container, the method comprising:
providing a container for holding said biomass and fluid, wherein said container comprises at least two horizontally aligned orifices;
elevating a fluid level of said fluid in said container to a height of at least one of said horizontally aligned orifices; and
flowing a carrier fluid through at least one of said horizontally aligned orifices to stream at least a portion of a top layer of said floating biomass out of said container and through at least one other of said horizontally aligned orifices, thereby transferring at least one layer portion of said floating biomass from said container out of said container.

2. The method according to claim 1, further comprising:
continuing to flow the carrier fluid through the at least one of the horizontally aligned orifices to continue the stream of floating biomass out of said container through the at least one other orifice, of said horizontally aligned orifices, to transfer most of said floating biomass from said container out of said container.

3. The method according to claim 2, wherein the floating biomass is transferred out of the container until a minimal residue of less than 0.01% of an initial batch of biomass within the container is left in the container.

4. The method according to claim 2, wherein the floating biomass is transferred out of the container until a minimal residue of less than 30% of an initial batch of biomass within the container is left in the container.

5. The method according to claim 1, wherein the biomass is a floating aquatic plant culture.

6. The method according to claim 1, wherein the biomass is washed en route during the transferring of said biomass from the container.

7. The method according to claim 1, wherein the flow of the carrier fluid into the container is controlled for calculating a total volume amount of the biomass transferred from the container.

8. The method according to claim 7, wherein the biomass transferred from the container is circulated back into the container for calculating the total volume amount of the biomass that was in said container.

9. A device for transferring floating biomass, the device comprising:
a container for holding said floating biomass and fluid and comprising at least two orifices, wherein said at least two orifices are horizontally aligned for flowing carrier fluid through at least one of said horizontally aligned orifices to stream at least a portion of a top layer of said floating biomass out of said container and through at least one other of said horizontally aligned orifices, thereby transferring at least one layer portion of said floating biomass from said container out of said container.

10. The device according to claim 9, wherein the angle between two horizontally aligned orifices, as viewed from above, is between 90-180. degrees.

11. The device according to claim 9, where the container comprises a tank and a top.

12. The device according to claim 11, wherein the container further comprises a truncated cone shaped head attached between the tank and the top.

13. The device according to claim 12, wherein the container further comprises strap that attaches the head and the top.

14. The device according to claim 11, wherein the top is shaped like a circular dome.

15. The device according to claim 11, wherein a circular base of the top has a diameter of between 20 mm to 80 mm.
